(19) United States
(12) Patent Application Publication
(10) Pub. No.: US 2014/0204613 A1
(43) Pub. Date: Jul. 24, 2014

(54) PROVIDING CONTROL POWER WITH A PHOTOVOLTAIC SYSTEM

(71) Applicant: SMA Solar Technology AG, Niestetal (DE)

(72) Inventors: Jonathan Blanz, Grebenstein (DE); Volker Wachenfeld, Hofgeismar (DE); Stijn Stevens, Staufenberg (DE); Jens Friebe, Vellmar (DE)

(21) Appl. No.: 14/220,348

(22) Filed: Mar. 20, 2014

Related U.S. Application Data
(63) Continuation of application No. PCT/EP2012/068371, filed on Sep. 18, 2012.

(30) Foreign Application Priority Data
Sep. 20, 2011 (DE) 10 2011 053 789.9
Oct. 31, 2011 (DE) 10 2011 054 971.4

(51) Int. Cl. H02M 7/42; H01L 31/042

(52) U.S. Cl. CPC H02M 7/42; H02S 40/00
USPC 363/13

(57) ABSTRACT

For controlling a photovoltaic system connected to an AC power grid and including a photovoltaic generator and an inverter, electric power which includes positive and negative dynamic control power is transferred by means of the inverter between the photovoltaic generator and the AC power grid as a function of a received power control signal.

### REFERENCE TO RELATED APPLICATIONS

This application is a continuation of International Application number PCT/EP2012/068371 filed on Sep. 18, 2012, which claims priority to German Application number 10 2011 053 789.9 filed Sep. 20, 2011 and German Application number 10 2011 054 971.4 filed Oct. 31, 2011.

### FIELD

The disclosure relates to a method of controlling a photovoltaic system which is connected to an AC power grid, which includes a photovoltaic generator and an inverter. Further, the disclosure relates to an inverter for feeding electric power from a photovoltaic generator into an AC power grid which comprises a controller executing such a method.

### BACKGROUND

A method and an inverter comprising a controller for executing such a method are inter alia known from EP 2 337 179 A1. Whereas, in the normal case, the maximum electric power of the connected photovoltaic generator, with the inverter of a photovoltaic system, is fed into a connected AC power grid, due to a ripple control signal transmitted by the operator of the AC power grid, this feeding power, is reduced to, for example, a predetermined percentage of the nominal power of the photovoltaic generators. In this way, the operator may reduce a destabilizing excess supply of electric power in the AC power grid. In the cases of such a compulsorily reduced feeding power, the operator of the respective photovoltaic system is entitled to a monetary compensation also for the feeding power which has potentially been possible but which has in fact not been fed in, so this feeding power has additionally to be recorded.

For decentralized controlling generators connected to an AC power grid, it is generally known to control their feeding powers depending on the grid frequency of the AC power grid, i.e. on the frequency of the AC voltage which is present in the AC power grid. With decreasing supply of electric power in the AC power grid, the grid frequency decreases in a way corresponding to the reduced rotation frequency of an electric machine used as a generator under excessive load.

It is known that photovoltaic systems which are provided for feeding electric energy into an AC power grid may also take energy out of a connected AC power grid, if only little or insufficient electric power is available from their photovoltaic generator to, for example, feed an onboard supply system by which the controller of their inverter is supplied.

From DE 10 2006 030 751 A1 it is known to reverse the energy flow direction from a photovoltaic generator into an AC power grid to melt down snow or ice on its photovoltaic modules which affect the function of the photovoltaic generator. In this way, it is also avoided that high snow loads build up on the photovoltaic modules or on a roof to which the photovoltaic modules are mounted.

Owing to circumstances, the electric power provided by a photovoltaic system may display relevant variations. If, for example, single clouds move at noon, the electric power may quickly vary between a maximum value and a value which is reduced by several 10 percent with regard to this maximum value. In order to limit the resulting variations of the supply of electric power in an AC power grid into which the photovoltaic system feeds, it is discussed to reduce the maximum power of an inverter of a photovoltaic system to, for example, 70% of the maximum power of all connected photovoltaic generators. In this way, the power peaks of the photovoltaic generators would no longer reach the AC power grid. In this context, one also refers to “peak shaving”. However, the electric power included in these not fed in power peaks gets lost.

Further, it is known to provide control power or balancing power for an AC power grid by means of a battery which serves as an intermediate storage for electric energy and by means of a battery inverter bidirectionally connecting the battery to the AC power grid. In this case, however, the battery should never be loaded completely but only by about one half to be able to both forward electric power into the AC power grid and take up electric power from the AC power grid if needed. Correspondingly, the storage capacitance of the battery has to be chosen very high as compared to the realized control power, particularly if the control power has to be provided over a longer period of time.

### SUMMARY

The disclosure provides a method of controlling a photovoltaic system and an inverter comprising a controller for executing such a method, which increase the functionality of a photovoltaic system and thus the potential earnings of the operator of the photovoltaic system, and which provide an active contribution to grid support.

In the new method of controlling a photovoltaic system which is connected to an AC power grid and which comprises a photovoltaic generator and an inverter, wherein a power control signal is received and wherein electric power is transferred between the photovoltaic generator and the AC power grid by means of the inverter as a function of the power control signal, the electric power transferred between the photovoltaic generator and the AC power grid as a function of the power control signal includes negative and positive dynamic control power.

Here, the term control power relates to a power component which is a deviation of the fed-in total power from a basic power, wherein the basic power is that power which the photovoltaic system feeds-in at a power control signal of zero or with no power control signal (i.e. with uncontrolled feeding-in). Positive control power thus designates that power component of the total power fed into the AC power grid by means of the inverter which, due to the power control signal provided by the operator, is fed into the AC power grid in addition to the basic power. Negative control power correspondingly designates that power component by which the basic power is reduced and which, even with regard to its absolute value, may be higher than the basic power, which means that the photovoltaic system then takes power out of the grid.

Dynamic control power here designates control power which is controllable within a short period of time of few seconds at maximum. In one embodiment, such dynamic control power can effectively be adjusted within 3 seconds at maximum, or within 1 second at maximum in another embodiment, or within half a second at maximum in still another embodiment.

In this way, control power for the AC power grid is provided by means of the photovoltaic system, which goes far beyond down-regulating the electric power fed into the AC power grid. In one embodiment, the electric power provided by a photovoltaic system may be highly dynamically varied in a large range by means of variably controlling its inverter such that the positive and negative control power provided according to the present disclosure are dynamic control power and can be used for dynamically stabilizing the AC power grid. As a result, the control power provided by means of the photovoltaic system is particularly valuable and, correspondingly, has a good chance of a high monetary compensation. The bandwidth of the monetary compensation for control power is very high, wherein even the monetary compensation for negative control power gets close to the monetary compensation for fed-in power and may even exceed it. Providing control power by means of a photovoltaic system thus opens a considerable additional income opportunity for its operator.

The capability of variably controlling an inverter resulting in a variable fed-in power is an inherent feature of many commercially available inverters such that no particular effort has to be spent for the application of the method according to the present disclosure at this point. The time constant which is typically realizable without problem in providing control power according to the disclosure is less than 0.1 s.

Starting from an amount of electric power which, at a control power of zero, is fed by the photovoltaic system into the connected AC power grid, even providing negative control power according to the present disclosure may be limited to a variation of this electric power in the positive range. Providing positive and negative control power according to the disclosure may, however, also include that electric power, as a function of the power control signal, is transferred between the inverter and the AC power grid in both directions. This means that the photovoltaic system, in providing negative control power, purposefully takes electric power out of the AC power grid.

For this purpose, the electric power may be transferred with the inverter in both directions between the photovoltaic generator and the AC power grid, as a function of the power control signal. Thus, if needed, electric power out of the AC power grid is directed to the photovoltaic generator and dissipated into heat there. That this is possible in principle is known from DE 10 2006 030 751 A1 cited at the beginning and from corresponding publications. It is new, however, to use this option for stabilizing an AC power grid. In this context it turns out that inverters of present photovoltaic systems may not only very quickly alter the amount of the transferred electric power but also the direction of the power flow between the photovoltaic generator and the AC power grid which is very advantageous for the dynamic stabilization of the AC power grid. The option of providing valuable negative control power with a photovoltaic generator could not be envisaged by one skilled in the art from the publications which relate to de-icing photovoltaic modules of a photovoltaic generator by taking up electric power out of a connected AC power grid. Here, the costs of this de-icing are only compared to the additional feed-in power of the de-iced photovoltaic generator enabled in this way and to unload a roof to which the photovoltaic modules are mounted.

To create the basis for the provision of positive control power according to the disclosure, the photovoltaic generator, at a control power of zero, may be operated in an operation point in which it supplies an electric power which is reduced as compared to its MPP. The range of the power up to the MPP, the operation point of maximum power, is then available as positive control power. Particularly, the reduced electric power may be reduced by a predetermined absolute value or a predetermined percentage value as compared to the electric power at the MPP. As a general rule, the reduced electric power is not more than 70% of the electric power at the MPP. In one embodiment, it is not more than 50%, and in another embodiment not more than 30% of the electric power at the MPP. Even a reduction of the power at the operation point to zero percent of the electric power at the MPP is possible to provide the entire potential electric power of the photovoltaic generator as positive control power. Both the absolute value and the percentage reduction may be determined by the operator, for example as a function of a grid condition or by means of a value transmitted by an external system. Generally, the reduced electric power may be mathematically determined from the available generator power and/or the maximum inverter power and/or the maximum generator power and may, if needed, additionally be determined from electric quantities of the grid.

It is possible to only reduce the power, when the fed-in power exceeds a threshold value so that in case of feed-in powers below the threshold value the MPP power is fed-in and, correspondingly, only negative control power is provided.

In one embodiment, the operation point at a control power of zero is shifted with regard to the MPP in such a way that an increase of the power fed out of a DC voltage link of the inverter automatically shifts the operation point of the photovoltaic generator connected thereto in the direction towards the MPP. This is the case, if the generator voltage in the operation point with reduced electric power is higher than the MPP voltage. In this way, the desired control power in case of application of a corresponding power control signal is available at maximum speed and with little control effort within the inverter.

In one embodiment of the method according to the disclosure, the electric power, as a function of the power control signal, is additionally also transferred from and to an intermediate storage for electric power. Typically this is a suitable battery, as a general rule an accumulator, like for example in form of a lithium ion battery. Generally, the intermediate storage for electric power may also operate according to the capacitor principle and may, for example, comprise so-called supercaps. It is also possible to make up the intermediate storage by means of an electrolysis cell and a fuel cell which may also be the same components operated in different modes. Of course, conventional intermediate storages, like for example a fly wheel, may also be considered. By means of the battery, it will be possible to provide positive control power permanently, e.g. also during the night. Here, it is an advantage that the battery may be charged by means of negative control power, but that no storage volume for the intake of further electric power has to be kept free in the battery, as, in the method according to the disclosure, the photovoltaic generator is available for this purpose. In that the battery may, thus, be completely charged, the entire battery charge is available as positive control power and the entire power intake capacity of the photovoltaic generator is available as negative control power during the night, when the photovoltaic generator cannot provide electric power. Correspondingly, the battery, as compared to a battery which, according to the prior art, has also to intake negative control power, may be essentially smaller and thus of lower cost. Additionally, charging the battery may more strongly consider the aspect of a long lifetime of the battery. Particularly, in the method according to the disclosure, the battery may be charged with electric energy from the photovoltaic generator which is surplus due to positive control power which has been provided but which has not been utilized.

Further, in the method according to the disclosure, the operation point of the photovoltaic generator, in which it is operated at a control power of zero, may be set as a function of the charging state of the battery. The higher the charging state, the less use needs to be made of the photovoltaic generator for the positive control power, because the battery is available. As a result, a higher portion of the potentially available electric power may be used. In practice, the photovoltaic generator may thus always be operated close to its MPP. Doing so, at first only a portion of the generated electric power is fed into the AC power grid; the remainder is used to charge the battery. With increasing charging state of the battery, the portion of the generated electric energy fed into the AC power grid is increased. In doing so, the battery may not only provide the additional positive control power but also compensate for, i.e. buffer, fluctuations of the electric power from the photovoltaic generator. For this purpose, it may be suitable to divide up the battery into several parts which include a part for electric energy to be quickly shifted forth and back, like for example on a capacitive basis, and a part for higher amounts of electric energy, like for example on an electrochemical basis, as with only one part the demands on the battery may only be fulfilled poorly.

Generally, an additional load may also be provided in the new method to provide for additional negative control power beyond that level that can be realized with the photovoltaic generator operated in reverse direction as a load. Such a load exclusively provided for dissipating electric energy, i.e. for its transformation into heat, however, does not belong to all embodiments of the present disclosure.

In the new method, the power control signal is not limited to low frequency ripple control signals as they are used to date to limit the power output of photovoltaic systems and other energy sources feeding into an AC power grid in case of an excess supply of electric power in the AC power grid. Instead, the power control signal may vary with just that frequency at which an operator wants to control the electric power available in the AC power grid.

The power control signal, as a function of which electric power, via the inverter, is transferred in both directions between the photovoltaic generator and/or the intermediate storage and the AC power grid in the method of the disclosure, may be directly transmitted from the respective operator of the AC power grid to the individual photovoltaic systems or to all photovoltaic systems connected to the AC power grid. Here, the transfer of the power control signal may take place wirelessly or wire-bound, like for example via the AC power grid itself or via the fixed line network or via a mobile network or via the Internet.

It is also possible to derive the power control signal for the photovoltaic system from the grid frequency of the AC power grid, which is equivalent to using the grid frequency of the AC power grid as a power control signal. Thus, at a low grid frequency of the AC power grid, the photovoltaic system may feed a positive control power up to the electric power which may be generated by the photovoltaic generator at maximum into the AC power grid, whereas, at a high grid frequency of the AC power grid, it provides a negative control power up to the maximum electrical power intake into its photovoltaic generator. With grid frequencies in between, all intermediate states with regard to feeding or intaking electric power are possible. Here, the thermal time constants of the involved components (i.e. their heating up rates at overload) may also be utilized, resulting in that for a short time powers may be adjusted which are partially essentially higher than in case of a thermally balanced state.

In the method of the disclosure, it is realistic to transfer electric power up to the nominal power of the photovoltaic generator from the AC power grid into the photovoltaic generator. This at least applies, if the photovoltaic generator is only subjected to no or only a low insolation. With a maximum insolation, the temperature of the photovoltaic modules of the photovoltaic generators may increase to non-acceptable values due to the intake of electric power, as the transformation of light power into electric power instead of heat, which occurs in the normal operation of the photovoltaic generator, is omitted. At these points in time, however, a negative control power of the height of the nominal power of the photovoltaic generator is already provided by means of down-regulating a photovoltaic system. From this point of view, a photovoltaic system which is operated according to the method of the disclosure may always provide its nominal power as negative control power, independently on the actual insolation.

To not endanger the integrity of the photovoltaic generator by transferring electric power out of the AC power grid into the photovoltaic generator, it may be cared for that the electric power transferred into the photovoltaic generator keeps a maximum value. For example, the above mentioned nominal power of the photovoltaic generator may be used as this maximum value. Alternatively or additionally, a current flowing into the photovoltaic generator and/or a resulting temperature of the photovoltaic generator may be monitored for keeping a maximum value. Corresponding monitoring devices at inverters for feeding electric power from photovoltaic generators into an AC power grid or connections for sensors at photovoltaic generators are often provided anyway.

If the operator of the photovoltaic system is also fully paid for the electric power which could potentially be fed from the photovoltaic generator into the AC power grid but which is not fed-in due to a down-regulation of this power or due to power even being taken in from the AC power grid, the provision of paid control power by the photovoltaic system in any case means an additional income for its operator.

It shall be understood that the control power which is transferred between the photovoltaic generator and the AC power grid as a function of the power control signal has to be recorded to ask for a payment therefor. This control power provided on demand includes the negative control power which is taken in out of the AC power grid via the inverter as a function of the power control signal. It shall be understood that negative and positive control power are not recorded integratively but separately. This recording may also be a recording of peak values of the control power provided within recording intervals.

For the purpose of payment for it, the electric power which could potentially be fed from the photovoltaic generator into the AC power grid but which is not fed-in as a function of the power control signal is also to be recorded. At least in so far as this electric power is no quickly fluctuating peak power or in so far as it is not yet paid for with the control power, it does not matter why it is not fed in. The potential but not realized fed-in power is of interest, if a down regulation to a lower electric power takes place which is still fed into the AC power grid; and it is equally of interest, if electric power is even discharged out of the AC power grid into the photovoltaic generator.

To determine a reliable measure of the electric power which could be fed out of the photovoltaic generator into the AC power grid under the present insolation conditions but which is not fed-in due to the power control signal, a part, for example one of several strings, of the photovoltaic generator may be operated to generate maximum electric power. Based on this power, the potential power of the entire photovoltaic generator may be extrapolated. Depending on which power flow direction is presently demanded by the power control signal, this electric power may then still be fed into the AC power grid, or it must additionally be transformed into heat in other parts of the photovoltaic generator. In this way, however, the thermal load to the photovoltaic generator as a whole is not increased. Even the thermal load to the individual strings is not changed, if the string which is operated for generating the maximum electric power is interchanged. It shall be understood that the inverter has to have a special design to be able to operate several parts of the photovoltaic generator differently. At least for each of these parts of the photovoltaic generator, an own separately operable input side DC/DC converter must be provided in the inverter.

A further way of determining the potential power of a photovoltaic system which is operated at reduced feed-in power consists of determining the MPP by short-term scanning the characteristic and to repeat this determination at regular intervals. If the characteristic is quickly scanned, resulting power fluctuations may even be buffered without an additional battery by means of the intermediate link capacitors usually present in an inverter.

Besides a controller for implementing the method according to the disclosure, the inverter according to the disclosure in one embodiment comprises a connection for a battery comprising a bidirectional battery inverter. A surveying device may be provided for surveying the electric power transferred into the photovoltaic generator, a current flowing into the photovoltaic generator in this case and/or a resulting temperature of the photovoltaic generator. Further, besides the usual meters for the electric power fed into the AC power grid and for electric power potentially taken out of the AC power grid for operating the inverter, in one embodiment additional meters are provided for electric power which is transferred by the controller between the photovoltaic generator and the AC power grid as a function of the power control signal, i.e. for the supplied control power, suitably separated between positive and negative control power, and for electric power which could potentially be fed from the photovoltaic generator into the AC power grid but which is not fed-in as a function of the power control signal.

It shall be understood that the inverter according to the disclosure has to have a sufficient maximum power to be able to implement the method according to the disclosure. Particularly, besides the electric power which is already fed into the AC power grid at a control power of zero, it must also be able to transfer the provided positive control power into the AC power grid, independently of whether it comes from the photovoltaic generator or a battery. Here, it may be utilized that the inverter may, for a limited time, feed a power value into the grid, which may be considerably higher than the limit for permanently feeding-in.

Advantageous further developments of the disclosure result from the claims, the description and the drawings. The advantages of features and of combinations of a plurality of features mentioned at the beginning of the description only serve as examples and may be effective alternatively or cumulatively without the necessity of all embodiments according to the disclosure having to obtain these advantages. Without changing the scope of protection as defined by the enclosed claims, the following applies with respect to the disclosure of the original application and the patent: further features may be taken from the drawings, in particular from the illustrated designs and the dimensions of a plurality of components with respect to one another as well as from their relative arrangement and their operative connection. The combination of features of different embodiments of the disclosure or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the disclosure do not have the features mentioned in the claims.

### BRIEF DESCRIPTION OF THE DRAWINGS

In the following, the disclosure will be further explained and described by means of preferred embodiment examples depicted in the drawings.

FIG. 1 is a schematic diagram of a first embodiment of the present disclosure, and

FIG. 2 is a schematic diagram of a second embodiment of the present disclosure.

### DETAILED DESCRIPTION

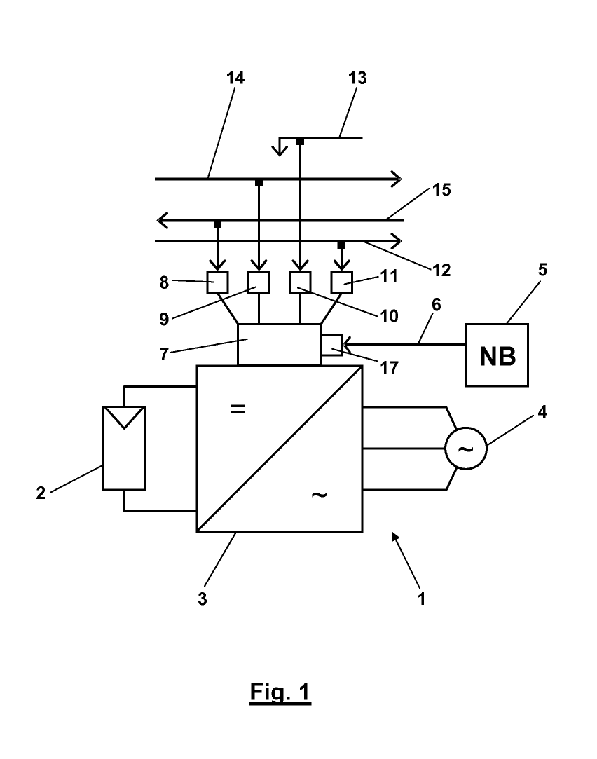

FIG. 1 illustrates a photovoltaic system 1 comprising a photovoltaic generator and an inverter 3. The inverter 3 is primarily provided for feeding electric power from the photovoltaic generator 2 into a connected AC power grid 4. For the purpose of stabilizing the AC power grid 4 with regard to the supply of electric power, an operator 5 may act upon a controller 7 of the inverter 3 by means of a power control signal 6 to demand control power from the inverter 3. When the inverter 3 actually feeds electric power into the AC power grid 4, negative control power is primarily realized in that this electric power is reduced, i.e. down-regulated. Additionally, the inverter 3 may also be operated by the controller 7 in such a way that electric power out of the AC power grid 4 is transferred into the photovoltaic generator 2 and transformed into heat there. With a strong insolation onto the photovoltaic generator 2, this transferable power may, depending on the circumstances, be limited. In any case, however, the photovoltaic system 1 as compared to its not down-regulated operation provides a negative control power of the height of the nominal power of the photovoltaic generator 2. Already for providing such a negative control power, the operator of the photovoltaic system 1 may ask for a payment by the operator 5. At any rate, he may ask for a payment for actually demanded negative control power. Additional positive control power is provided by the inverter 3 in that, at a control power of zero, it operates the photovoltaic generator 2 in an operation point which is below its MPP with regard to the power. This power reduction is thus available as positive control power.

In the example according to FIG. 1, a total of four meters 8 to 11 is depicted which are connected to the photovoltaic system 1 and which meter different powers, i.e. integrate them over the time to record the basis for a payment for the respective power. Here, the power flow direction is depicted in form of arrows in the upper part of FIG. 1, wherein an arrow from left to right indicates a power flow from the photovoltaic generator 2 into the AC power grid 4. Meter 11 records the electric power 12 regularly fed from the photovoltaic generator 2 into the AC power grid 4. The meter 10 records the electric power 13 which is taken in by the inverter 3 out of the AC power grid 4 to, for example, supply its controller 7 with electric energy when this electric energy is not available from the photovoltaic generator 2 during the night. The meter 9 serves for recording demanded positive control power 14 which has been fed into the AC power grid 4 on demand by the power control signal 6. Vice versa, the meter 8 monitors the negative control power 15 which is transferred from the AC power grid 4, for its stabilization, into the photovoltaic generator 2, i.e. the actually demanded negative control power 15 of the photovoltaic system 1. Additionally, a further meter, not depicted here, may be provided for electric power which is potentially available from the photovoltaic generator but which is not fed-in due to the actual value of the power control signal 6. At least in Germany, the operator of the photovoltaic system 1 is paid for this electric power 14 in the same manner as for electric power 12 which is actually fed into the AC power grid 4.

Of course, recording the demanded positive and negative control power with a common meter may also be considered, for example by only recording the absolute values of the control power.

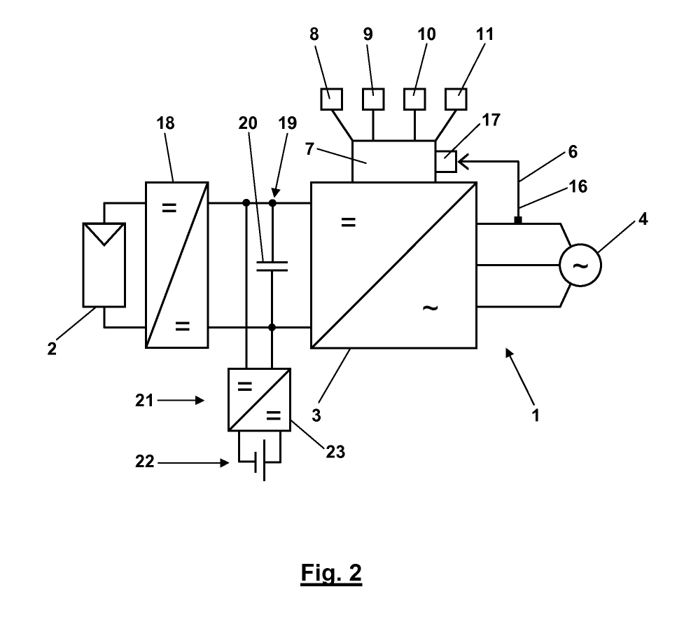

In FIG. 2, the same meters 8 to 11 as in FIG. 1 are provided, even if the powers 12 to 15 recorded by them are not indicated by direction arrows here. One difference of the photovoltaic system 1 according to FIG. 2 with regard to that one according to FIG. 1 is that the controller 7, via its receiver 17, does not receive a power control signal separately transmitted by an operator but a power control signal 6 in form of the grid frequency 16 of the AC power grid 4 which is identified by the voltage course at one of the connection lines of the inverter 3 to the AC power grid 4. Depending on the grid frequency, the controller 7 sets the control power which is presently provided by the photovoltaic system 1. Depending on the present insolation on the photovoltaic generator 2, it realizes the negative control power by regulating the electric power fed into the AC power grid 4 down and/or by taking in electric power out of the AC power grid into its photovoltaic generator 2.

Additionally, in the inverter 1 according to FIG. 2, besides the photovoltaic generator 2 which is connected to an input side DC voltage link 19 comprising an intermediate link capacitance 20 of the inverter 3 via a DC/DC converter 18, also a connection 21 for a battery 22 to the DC voltage link 19 is provided. In this connection 21 a bidirectional DC/DC converter is arranged as a battery inverter 23. By means of the battery 22, positive control power for the AC power grid 4 can be provided via the inverter 3, and with a sufficient dimension of the inverter this is independent of feeding electric power from the photovoltaic generator 2 into the AC power grid 4. The electric power from the photovoltaic generator 2 is less suited as positive control power for the AC power grid 4, as it depends on the insolation onto the photovoltaic generator 2 and is thus not at all available during the night. In the photovoltaic system 1 according to FIG. 2, however, the battery 22 may be charged with electric power out of the photovoltaic generator 2 and, if necessary, also by taking in electric power out of the AC power grid 4, and it may also be kept charged until positive control power is needed. Then, the electric power intermediately stored in the battery 22 is fed into the AC power grid 2 via the battery inverter 23 and the inverter 3.

1. A method of controlling a photovoltaic system connected to an AC power grid and comprising a photovoltaic generator and an inverter, comprising:
receiving a power control signal at the inverter; and
transferring electric power, as a function of the power control signal, between the photovoltaic generator and the AC power grid by means of the inverter,
wherein the electric power is transferred between the photovoltaic generator and the AC power grid in both directions as a function of the power control signal and includes positive and negative dynamic control power at differing times.

2. The method according to claim 1, wherein the electric power is transferred in both directions between the inverter and the AC power grid as a function of the power control signal at differing times.

3. The method according to claim 1, wherein, at a control power of zero, the photovoltaic generator is operated in an operation point in which it supplies an electric power reduced with regard to its maximum power point (MPP).

4. The method according to claim 3, wherein the reduced electric power is reduced by a predetermined absolute value or a predetermined percentage proportion with regard to the electric power at the MPP.

5. The method according to claim 1, further comprising using the electric power from and to an intermediate storage for electric power as a function of the power control signal.

6. The method according to claim 1, wherein the power control signal is transmitted to the inverter wirelessly or by wire, via the AC power grid, via a fixed line telephone network, via a mobile network, or via the Internet by an operator of the AC power grid.

7. The method according to claim 1, wherein the power control signal is a function of a state of the AC power grid.

8. The method according to claim 7, wherein the state of the AC power grid comprises a grid frequency of the AC power grid.

9. The method according to claim 1, wherein electric power up to a nominal power of the photovoltaic generator is transferred from the AC power grid into the photovoltaic generator based on the power control signal.

10. The method according to claim 1, further comprising monitoring one or more of:
the electric power transferred into the photovoltaic generator,
a resulting current flowing into the photovoltaic generator, or
a resulting temperature of the photovoltaic generator, for keeping a maximum value.

11. The method according to claim 1, further comprising recording the control power as a function of the power control signal that is transferred between the photovoltaic generator and the AC power grid.

12. The method according to claim 1, further comprising monitoring the electric power which could potentially be fed from the photovoltaic generator into the AC power grid but which, as a function of the power control signal, is not fed in.

13. An inverter for feeding electric energy from a photovoltaic generator into an AC power grid, comprising:
a receiver configured to receive a power control signal, and
a controller which, in operation of the inverter, is configured to control a transfer of positive and negative control power between the AC power grid by means of the photovoltaic generator in both directions as a function of the power control signal at differing times.

14. The inverter according to claim 13, further comprising a connection configured to couple to a battery as an intermediate storage for electric power.

15. The inverter according to claim 13, further comprising a monitoring device configured to monitor one or more of:
the electric power transferred into the photovoltaic generator,
a resulting current flowing in the photovoltaic generator, or
a resulting temperature of the photovoltaic generator.

16. The inverter according to claim 13, further comprising a meter configured to measure the positive and negative control power which, as a function of the power control signal, is transferred by the controller between the photovoltaic generator and the AC power grid.

17. The inverter according to claim 13, further comprising a meter configured to measure electric power which could potentially be fed from the photovoltaic generator into the AC power grid but which, as a function of the power control signal, is not fed-in.

18. The inverter according to claim 13, wherein the controller is configured to provide negative control power from the grid to the photovoltaic generator or an intermediate storage device based on a state of the AC power grid.

19. The inverter according to claim 18, wherein the state of the AC power grid comprises a frequency of the AC power grid.
